(19) United States
(12) Patent Application Publication
(10) Pub. No.: US 2007/0261941 A1
(43) Pub. Date: Nov. 15, 2007

(54) Dynamic motorized roller conveyor control

(75) Inventors: Wynn M. Pelak, Rockford, MI (US); Christopher W. Groom, Grand Rapids, MI (US); Adam T. Bouwens, Wyoming, MI (US); Daniel O. Amarandei, Kentwood, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Dematic Corp., Grand Rapids, MI (US)

(21) Appl. No.: 11/801,008

(22) Filed: May 8, 2007

Related U.S. Application Data
(60) Provisional application No. 60/746,901, filed on May 10, 2006.

(51) Int. Cl. B65G 13/06

(52) U.S. Cl. 198/781.05

(57) ABSTRACT

An article-conveying system and method of conveying articles includes providing a conveying surface and conveying articles with the conveying surface. The conveying surface defines a series of tandem zones, each of the zones including an article sensor and an actuator. Articles are sensed with the article sensor in the respective zone and the portion of the conveying surface at that zone is driven when the corresponding actuator is operated. Inputs are received from the article sensors at the zones and the actuators for the zones are controlled as a function of the inputs. This includes defining objects, each of the objects corresponding to one of said zones. Virtual signals are enabled between the objects. The virtual signals relate to movement of articles along the conveying surface.

### CROSS REFERENCE TO RELATED APPLICATION

This application claims priority from U.S. provisional patent application Ser. No. 60/746,901, filed on May 10, 2006, the disclosure of which is hereby incorporated herein by reference in its entirety.

### BACKGROUND OF THE INVENTION

The present invention is directed to an article-conveying system and, in particular, to an article-conveying system made up of a series of tandem zones, each of which may be separately driven. The invention is particularly useful with motorized roller driven zones, although other forms of propulsion may be used.

Conveyor systems may be made up of article-conveying surfaces that are divided into a series of tandem zones, each of which may be selectively actuated or deactuated. Such conveyor systems may perform useful functions, such as transporting articles, accumulating an excess flow of articles, diverting articles, merging articles, and the like. Examples of such article-conveying systems are disclosed in commonly assigned U.S. Pat. Nos. 6,811,018; 6,899,219; 6,971,510; and published U.S. Application 2004/0195078, the disclosures of which are hereby incorporated herein by reference. The ability to individually actuate each zone provides flexibility and control of the conveying system.

### SUMMARY OF THE INVENTION

An article-conveying system and method of conveying articles, according to an aspect of the invention, includes providing a conveying surface and conveying articles with the conveying surface. The conveying surface defines a series of tandem zones, each of the zones including an article sensor and an actuator. Articles are sensed with the article sensor in the respective zone and the portion of the conveying surface at that zone is driven when the corresponding actuator is operated. Inputs are received from the article sensors at the zones and the actuators for the zones are controlled as a function of the inputs. This includes defining objects, each of the objects corresponding to one of said zones. Virtual signals are enabled between the objects. The virtual signals relate to movement of articles along the conveying surface.

These and other objects, advantages and features of this invention will become apparent upon review of the following specification in conjunction with the drawings.

### BRIEF DESCRIPTION OF THE DRAWINGS

FIG. 1 is an electrical block diagram of a conveyor system useful with the invention;

FIG. 2 is a top plan view of a schematic representation of a single zone of the conveying system in FIG. 1;

FIG. 3 is a top plan view of a schematic representation of multiple tandem zones;

FIG. 4 is a block diagram of an electrical drive for an individual zone;

FIG. 5 is a block diagram of software objects representing zones showing virtual signals between the objects;

FIG. 6 is a schematic representation of zone data connection points between adjacent objects representing adjacent zones;

FIG. 7 is a top plan view of a right angle transfer device illustrating an induct function;

FIG. 8 is a flowchart of a logical call structure for calling functions;

FIG. 9 is a top plan view of an article-conveying system during sequential times illustrating operation of the conveyor system in a zero pressure accumulation mode;

FIG. 10 is the same view as FIG. 9 illustrating articles accumulated in a zero pressure accumulation mode;

FIG. 11 is the same view as FIG. 10 illustrating singulation discharge of the accumulated articles;

FIG. 12 is the same view as FIG. 11 illustrating train discharge of articles;

FIGS. 13a, 13b are a flowchart of a zero pressure accumulation mode function with singulation discharge;

FIGS. 14a, 14b are a flowchart of a zero pressure accumulation mode function with train discharge;

FIG. 15 is the same view as FIG. 9 illustrating operation of the article-conveying system in a zero gap accumulation mode;

FIG. 16 is the same view as FIG. 15 illustrating accumulation of articles in a zero gap accumulation mode;

FIG. 17 is the same view as FIG. 16 illustrating discharge of articles accumulated in a zero gap accumulation mode;

FIGS. 18a, 18b are a flowchart of a zero gap accumulation mode function;

FIG. 19 is the same view as FIG. 16 illustrating accumulation of articles in a zone accumulation mode;

FIG. 20 is the same view as FIG. 19 illustrating discharge of articles accumulated in a traditional accumulation mode;

FIG. 21 is the same view as FIG. 19 illustrating manual removal of a carton, or article, from among accumulated articles;

FIG. 22 is the same view as FIG. 21 illustrating a mode in which the gap is maintained if an article is manually removed;

FIG. 23 is the same view as FIG. 21 illustrating a mode in which accumulated articles move forward if an article is manually removed from accumulated articles;

FIG. 24 is a flowchart of a zone accumulation mode function;

FIG. 25 is a flowchart of another zone accumulation mode function;

FIG. 26 is the same view as FIG. 15 illustrating operation of the article-conveying system in a transportation mode;

FIG. 27 is a flowchart of a transportation mode function;

FIG. 28 is a diagram illustrating operation of a time release merge mode; and

FIG. 29 is the same view as FIG. 28 for use with multiple induct lines.

### DESCRIPTION OF THE PREFERRED EMBODIMENT

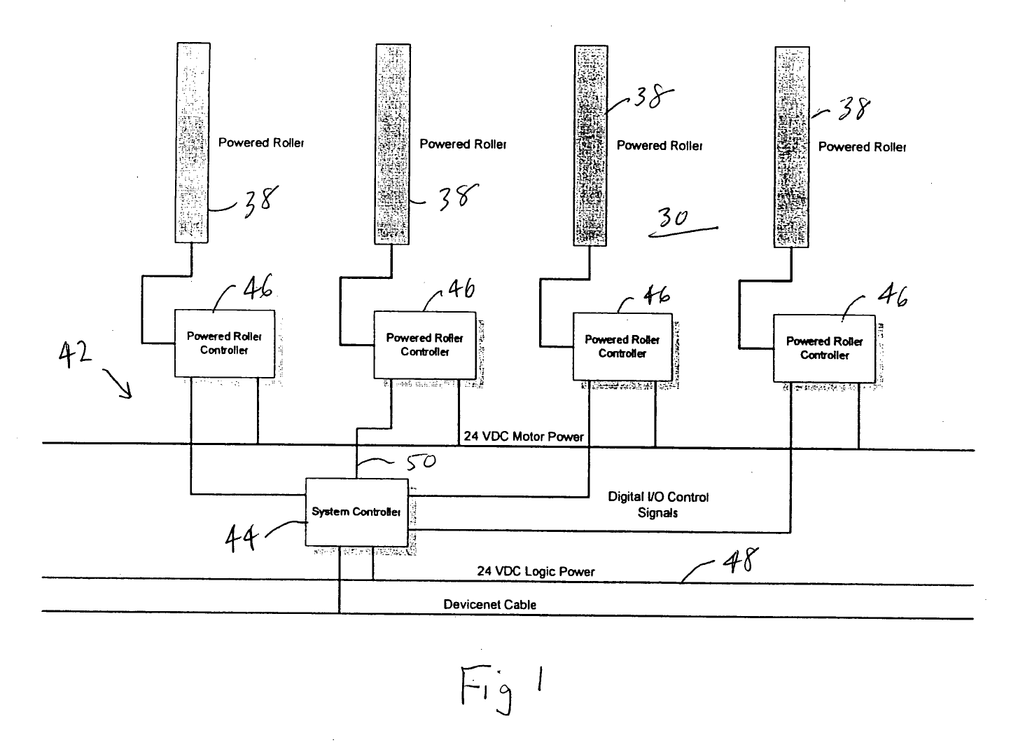

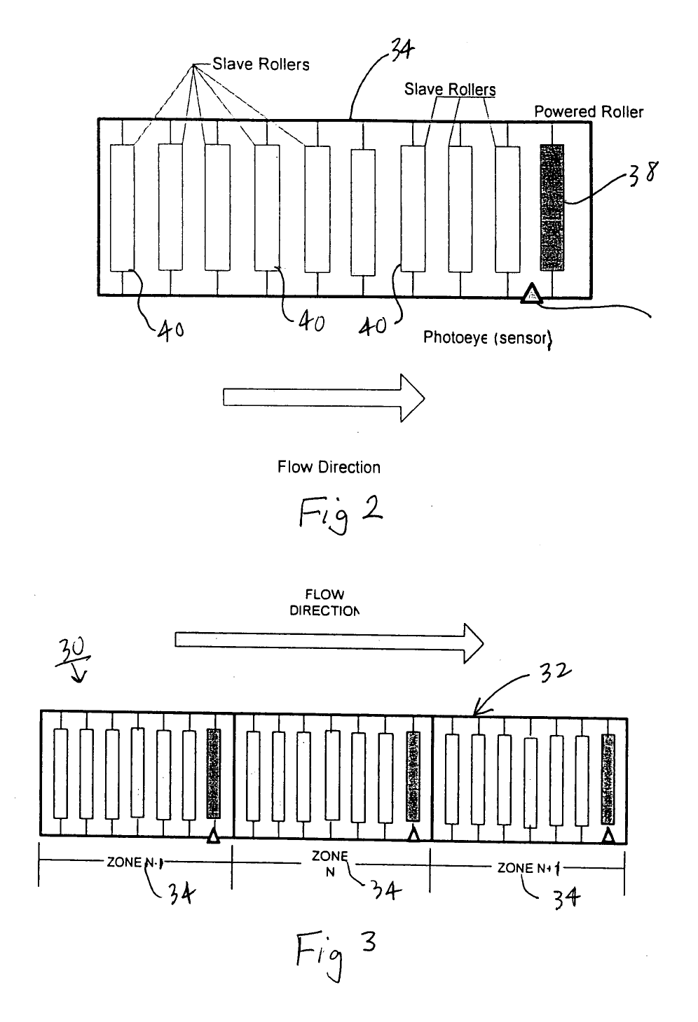

Referring now specifically to the drawings, and the illustrative embodiments depicted therein, an article-conveying system 30 is made up of a conveying surface 32 for conveying articles (FIGS. 1-3). Conveying surface 32 is divided into a series of zones 34, each including an article sensor, such as a photo sensor 36 and an actuator 38 for driving the portion of conveying surface 32 within the corresponding zone. In the illustrative embodiment, actuator 38 is a roller having a shell and an electrical motor (not shown) within that shell for rotating the shell (such device is also known as a “motorized roller”). Such motorized roller is well known to the skilled artisan and will not be described further. Motorized roller 38 drives the portion of conveying surface 32 within the corresponding zone. Such conveying surface may be made up of a series of slave rollers 40 which may be driven by motorized roller 38, such as by O-rings, as is well known in the art. Alternatively, the portion of the conveying surface within zone 32 may be a belt conveyor provided according to the principles set forth in commonly assigned U.S. Pat. No. 6,811,018, the disclosure of which is hereby incorporated herein by reference. Alternatively, the portion of conveying surface 32 within a zone may be driven utilizing a tape drive conveyor provided according to the principles set forth in commonly assigned U.S. Pat. No. 6,899,219, the disclosure of which is hereby incorporated herein by reference. Other configurations for the conveying surface will be apparent to the skilled artisan.

Article-conveying system 30 also includes a control generally shown at 42. Control 42 may be made up of a system controller 44 for controlling a plurality of zones and a series of powered roller controllers 46, each of which controls actuation of a powered roller, thereby controlling the corresponding zone. System controller 44 may be a bed-level controller as disclosed in commonly assigned U.S. Pat. No. 7,035,714 entitled INTEGRATED CONVEYOR BED, the disclosure of which is hereby incorporated herein by reference. System controller 44 may communicate with other system controllers as well as with a higher level controller (not shown) by way of a network 48. System controller 44 may control a plurality of powered roller controllers 46 by way of a low-level network 50. Alternatively, system controller 44 and a plurality of powered roller controllers 46 may be combined in a common circuit board utilizing the principles set forth in commonly assigned published U.S. Application 2006/0030968 entitled INTEGRATED CONTROL CARD FOR CONVEYING SYSTEMS, the disclosure of which is hereby incorporated by reference.

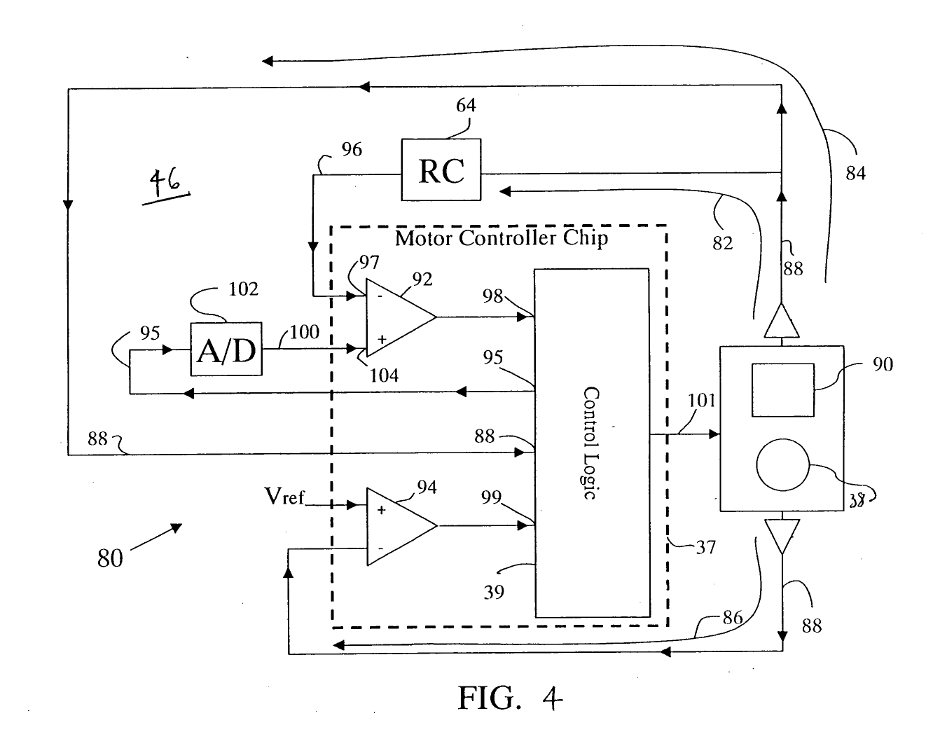

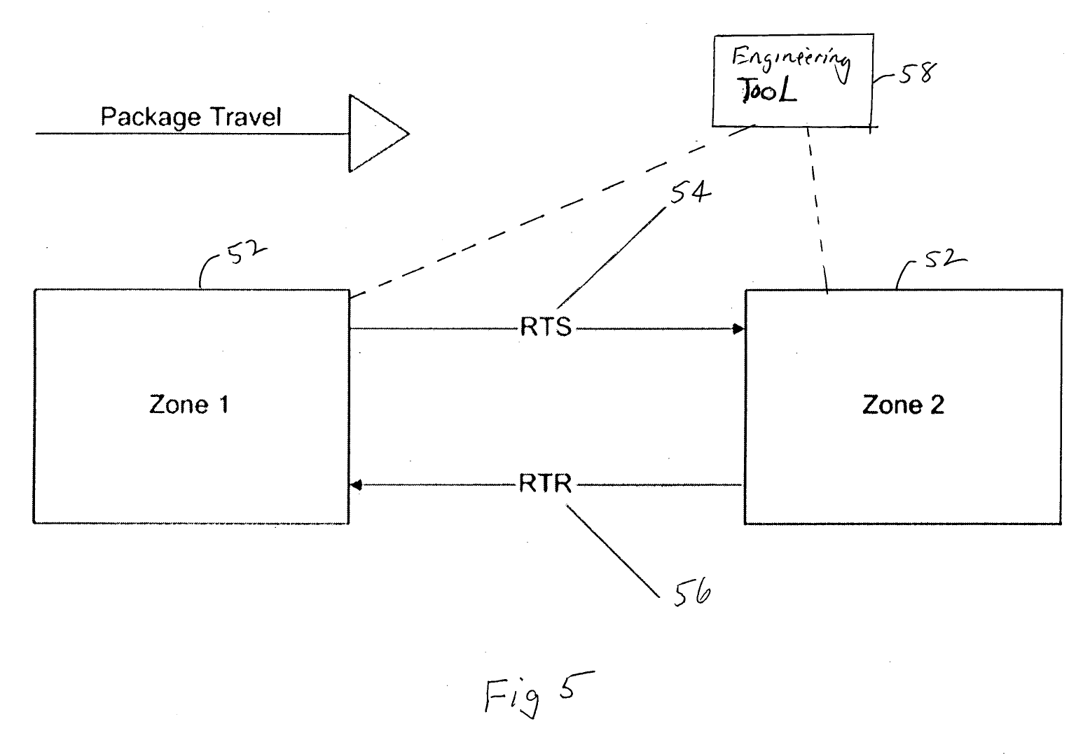

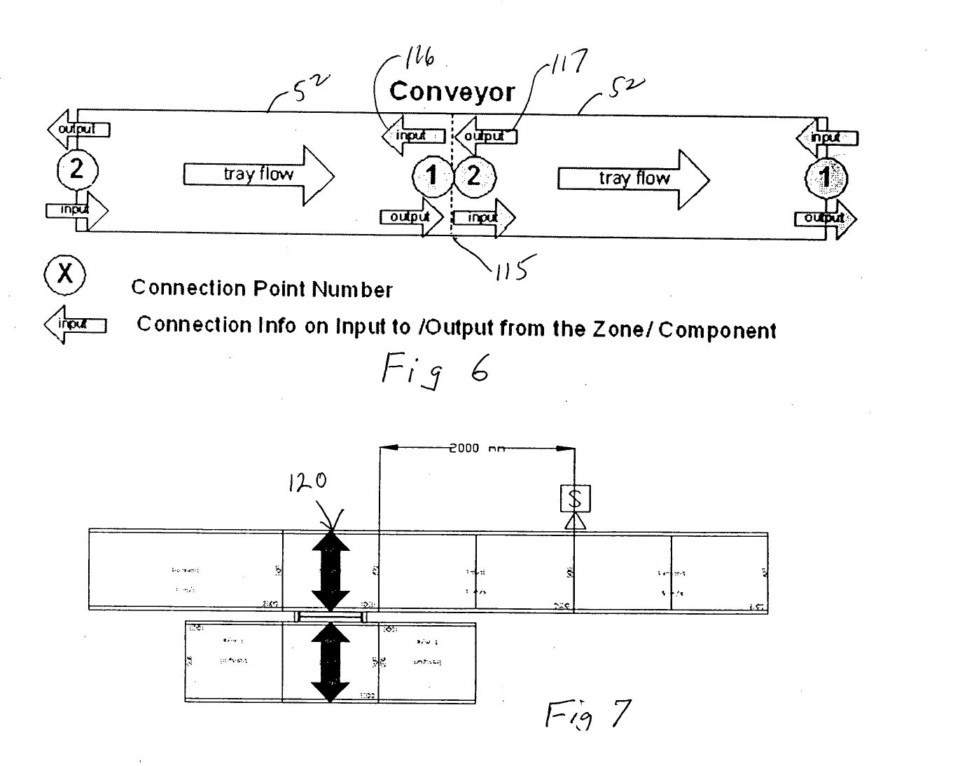

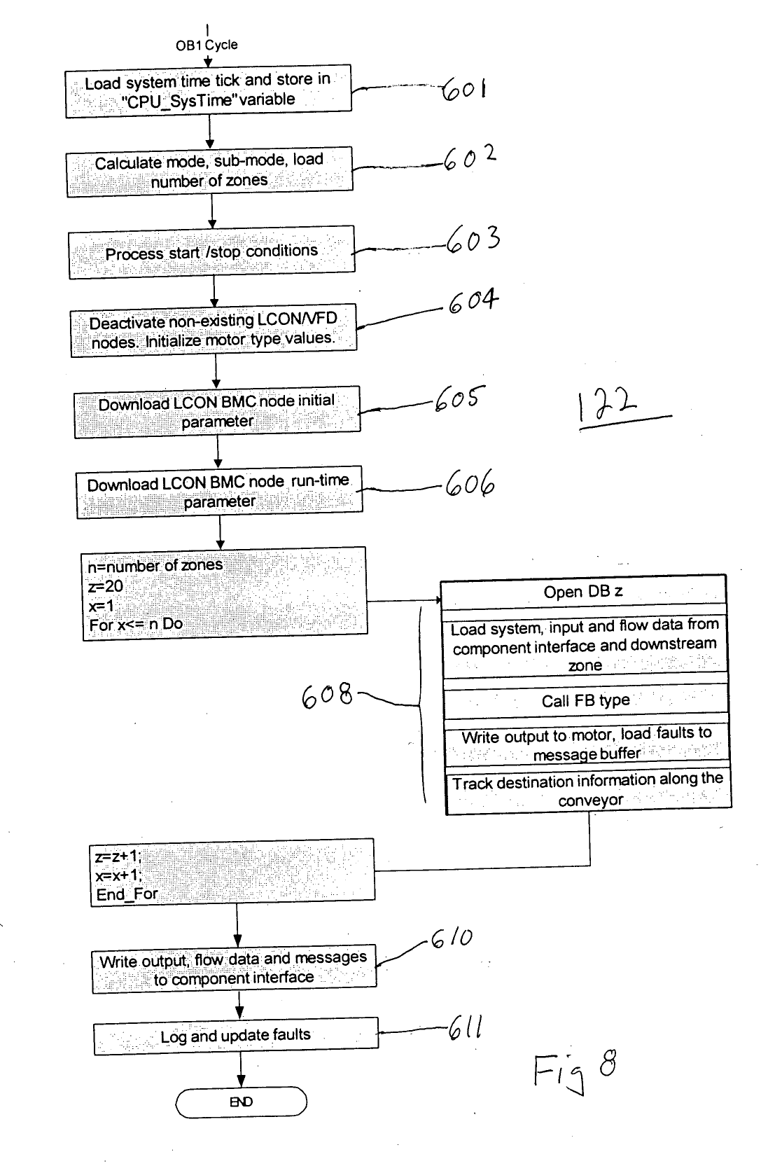

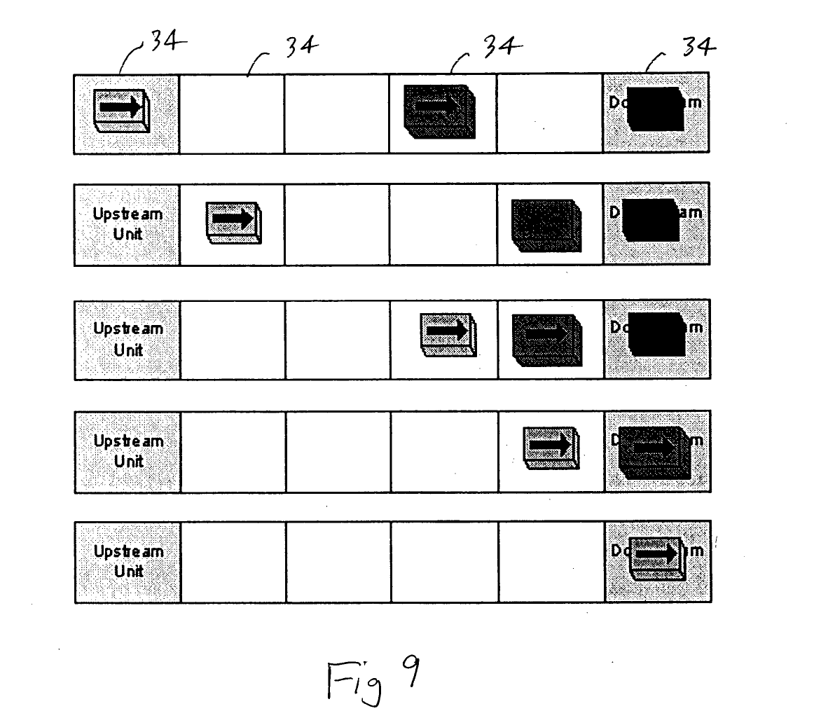

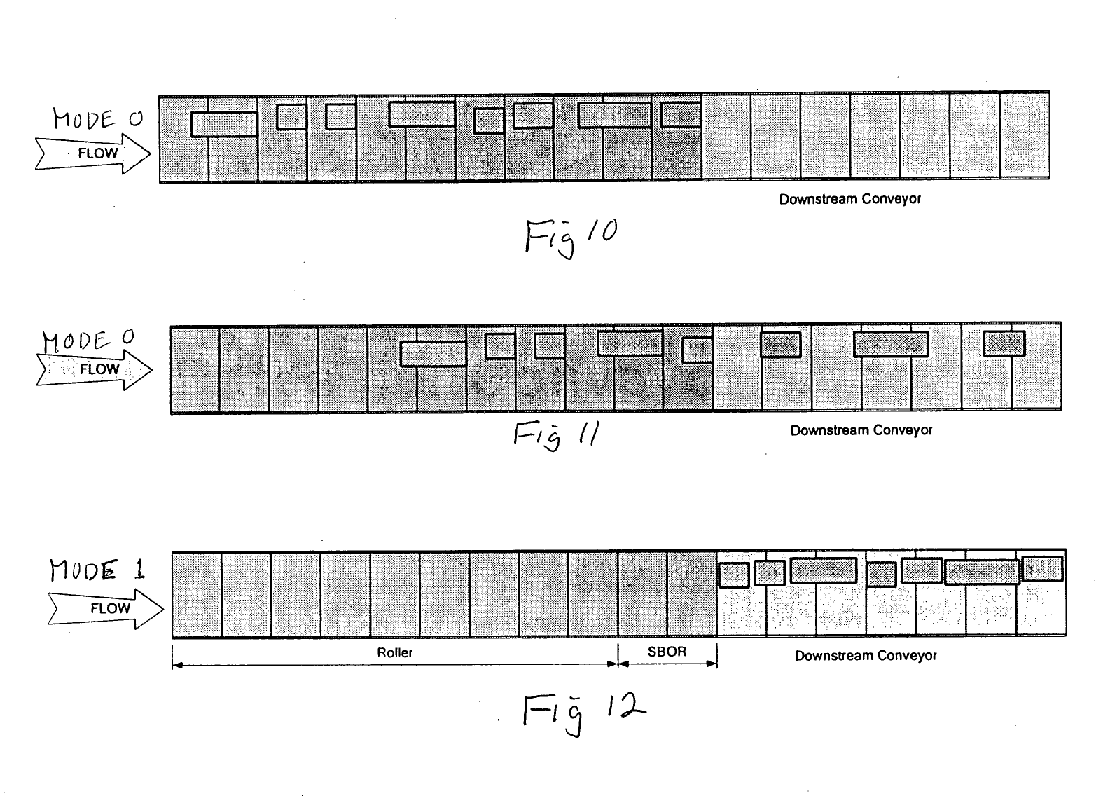

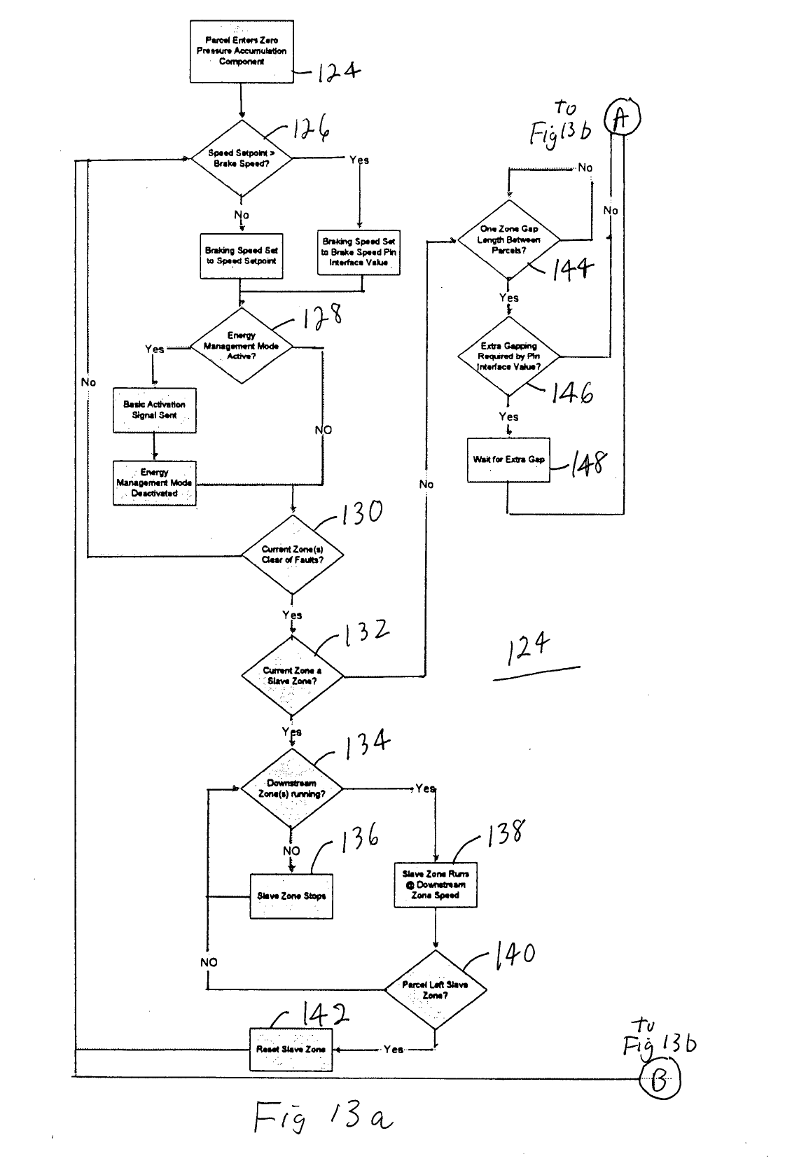

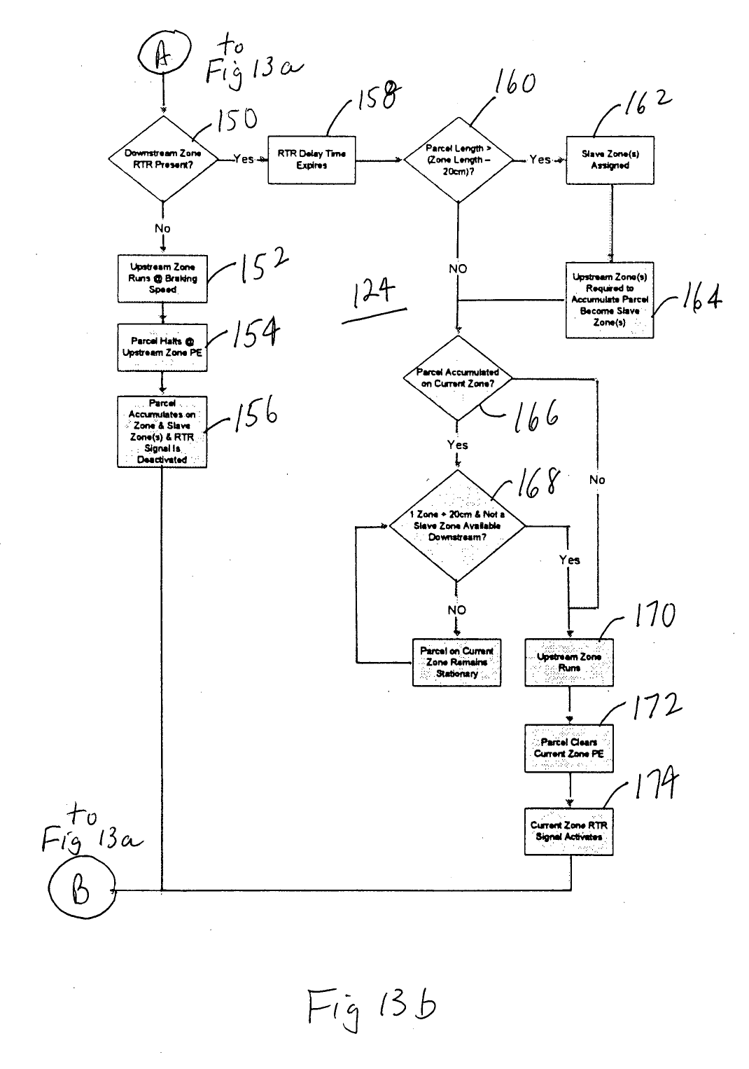

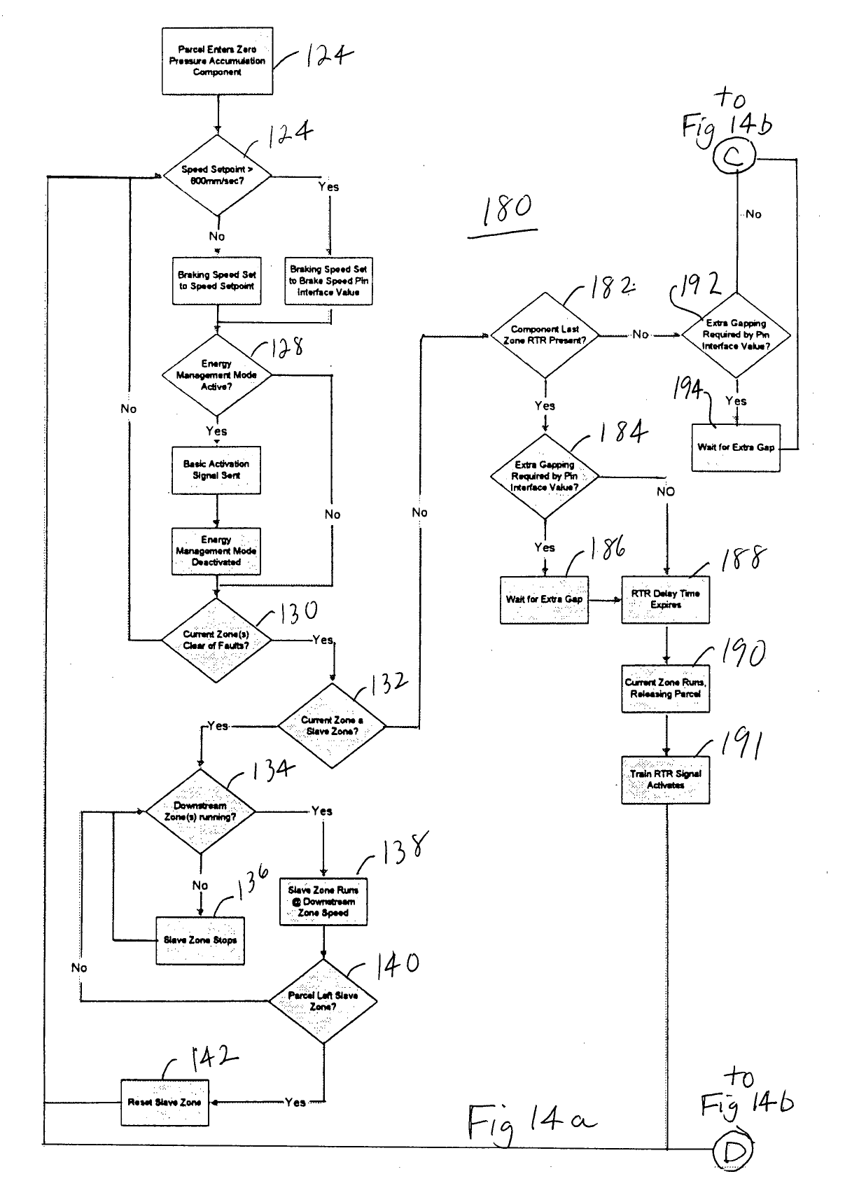

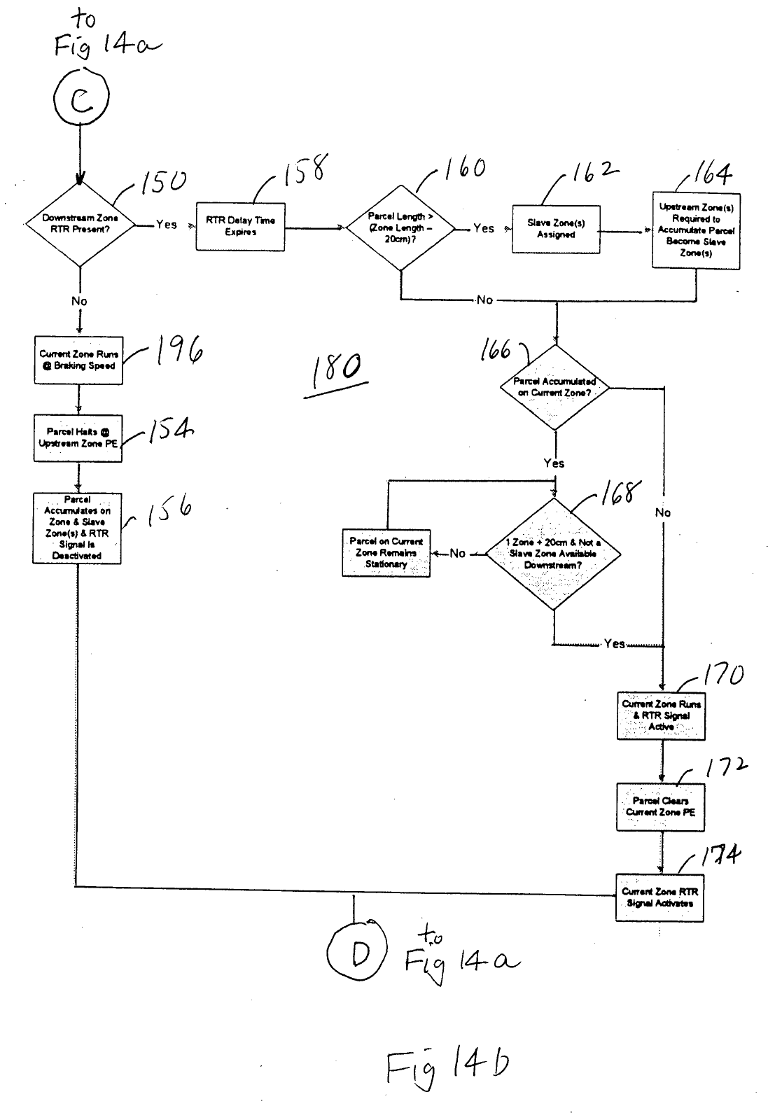

Powered roller controller 46 includes the capability of setting the speed, direction and position of powered roller 38 (FIG. 4). One example of controlling a motorized roller 38 is illustrated at 80. Circuit 80 includes a commercially available motor control chip 37 which operates in conjunction with sensors, such as Hall-effect sensors 90. Circuit 80 additionally includes a feedback loop controller 64 and a voltage comparator 66.

Motor controller chip 37, feedback loop controller 64, and voltage comparator 66 work together to process signals from a Hall-effect sensor 90 to produce an output signal 101 for controlling the speed, direction and position of brushless motor powered roller, or motorized roller, 38. Generally, Hall-effect sensors 90 provide a plurality of signals, preferably three signals, which may be processed by motor controller chip 37 to produce a fourth signal calculated from the first three signals. The four Hall-effect sensor signals are processed in a series of feedback control loops 80 to control the speed, direction and position of motors 12. Feedback control loops 80 constantly compare signals in order to adjust the speed, direction, and position of motors 12 according to either upper level controller commands or the local motor controller logic in motor controller circuit 46. Motor controller circuit 46 may also include brake control line 68 for controlling an optional conveyor roller brake (not shown). An example of one such conveyor roller brake is disclosed in commonly assigned U.S. Pat. No. 7,021,456 entitled CONVEYOR ROLLER WITH BRAKE, the disclosure of which is hereby incorporated herein by reference.

Feedback control loop circuit 80, in the illustrative embodiment, includes three control loops: first inner analog control loop 82, second outer digital control loop 84, and third current control loop 86. Control loop circuit 80 controls motorized roller 38 through motor controller chip 37 to control the speed, direction and/or position of the motorized rollers. As is conventional, motorized roller 38 includes a Hall-effect commutator 90 to produce a series of output Hall-effect commutative signals 88. Output Hall-effect commutative signals 88 may include a plurality of pulse-width Hall-effect commutator signals. Motor controller chip 37 includes a control logic circuit 39, an operational error amplifier 92 and a current operational amplifier 94 integrated in motor controller chip 37.

First inner control loop 82 is a hardware feedback control loop using a feedback loop controller 64 to maintain the speed of motorized roller 38. Feedback loop controller 64 includes a resistor-capacitor time constant circuit, as is known in the art. The resistor-capacitor time constant circuit of feedback loop controller 64 sets the pulse-width of output pulse signal 88. Feedback loop controller 64 detects output Hall-effect commutative signals 88 on every signal transition edge and generates a first analog fixed pulse-width signal 96. First analog fixed pulse-width signal 96 is received by negative input 97 of error amplifier 92. As motor 12 goes faster, the motor produces pulses at higher frequency and will increase the DC voltage to negative input 97 of error amplifier 92.

Motor controller chip 37 controls second outer digital control loop 84. Motor controller chip 37 receives output Hall-effect commutative signals 88 to derive speed information. Motor controller chip 37 monitors the speed information from Hall-effect commutator 90 and generates a digital signal 95 for the desired speed. Digital signal 95 is converted to speed command signal 100 by serial A/D converter 102. Speed command signal 100 is received by positive input 104 of error amplifier 92.

Error amplifier 92 compares voltages of first analog fixed pulse-width signal 96 and speed command signal 100 to send error voltage output 98 to control logic circuit of motor controller 36 to slow down or speed up motor 12 as required to maintain the set speed. Second outer digital control loop 84 controls the overall required speed as dictated by microcontroller 34. First inner analog control loop 82 maintains the required speed of motorized roller 38 as dictated by second outer digital control loop 84.

Third current control loop 86 receives output Hall-effect commutative signals 88 to negative input of current control loop amplifier 94. The positive input of current control loop amplifier 94 is a, for example, 0.1 V internal reference voltage generated by motor controller chip 37. Current control loop amplifier 94 produces current control loop output 99. Current control loop output 99 is received by control logic circuit of motor controller chip 37. Motor controller chip 37 uses output error voltage 98 and current control loop output 99 to determine the proper signal to send to motor 12. Motor controller chip 37 performs iterations to adjust the speed, direction, and position of motorized roller 38. The algorithm or program for controlling motorized roller 38 may be stored in a read/write memory of motor controller chip 37 or in a dedicated RAM device.

The three control loops are processed by motor controller chip 37 to produce a fourth signal, the four control loops control the position, speed and direction of the powered roller by controlling motorized roller 38. Hall-effect sensor 90 in each motor 12 provides precise position information that motor controller chip 37 can use to control motor 12. For example, if there is a requirement to move an item 2.5 feet on the conveying system, motor controller chip 37 may use output Hall-effect commutative signals 88 to activate motorized roller 38 to turn the powered roller for a specific number of revolutions, or portions of a revolution corresponding to a distance of 2.5 feet on the conveying system. Motor controller chip 37 can control partial revolutions of the motorized rollers up to 1/100^{th} of a revolution.

While one particular embodiment is disclosed for utilizing the output of Hall-effect sensors 90 to control the speed, direction, and position of motorized roller 38, it should be understood that other configurations would be apparent to the skilled artisan.

Control 42 receives inputs from article sensors 36 and actuates motorized rollers 38. Control 42 is programmed with software that defines a series of objects, such as virtual objects 52, each virtual object corresponding to one of the zones 35 (FIG. 5). Each virtual object 52 operates as an independent object. Objects 52 communicate with the objects associated with upstream and downstream zones utilizing virtual signals 54 and 56. Virtual signal 56 is a Ready-to-Receive signal (RTR) that is set by the downstream zone (illustrated as zone 2) when that zone is in a state to accept a new article or package and is used by the adjacent upstream zone (zone 1) to begin a package transfer. Signal 54 is a Ready-to-Send signal (RTS) that is set by the upstream zone (zone 1) when a unit load, such as an article or package, is ready to be transferred and is used by the adjacent downstream zone (zone 2) to prepare to accept the package. As will be set forth in more detail below, zone 1 and zone 2 utilize signals 54 and 56 differently depending upon the mode set for the respective zone. Each zone may be independently set in a particular mode and the mode may be changed from time-to-time by the software operated on control 42, as will be discussed in more detail below. Thus, the manner in which a zone will react to signals 54, 56, as well as other signals and data, is determined by its mode of operation. Each zone can be configured utilizing an engineering tool 58 to have its particular mode of operation. Engineering tool 58 is a software tool for configuring the communications between virtual objects 52 in a distributed control system. It may be centrally programmed and may allow a single system controller 44 to control up to, by way of example, 31 zones 34. In the illustrative embodiment, engineering tool 58 is a Simatic iMAP engineering tool supplied by Siemens A. G., although other engineering tools for component-based automation may be utilized.

Adjacent objects 52 are connected by a connection point structure 115 (FIG. 6). Connection point structure 115 provides zone connection points that may be used for zone-to-zone and component-to-component communications. The connection points which include inputs 116 and outputs 117 are predefined depending upon the zone-running direction.

Because control 46 is able to control the speed, direction and position of the corresponding roller 38, articles may be tracked on conveying surface 32. One application of the tracking of articles by position includes gapping of the article with respect to leading or trailing articles for the purposes of a sortation and/or transfer operation. An example is illustrated with respect to an induct unit 120 which is the form of a right-angle transfer (RAT). The ability to gap, identify and track the articles according to their position allows the ability to transfer an article with RAT 120 with minimum gap between articles. Moreover, the position of the gaps between articles can be matched with the position of the RAT. This allows the reduction of gaps which increases the throughput of articles.

The software run by control 42 includes a logical call structure 122 (FIG. 8). Logical, or component, call structure 122 executes once every program cycle. All other functions are called either directly or indirectly with call structure 122, with the exception of interrupts caused by hardware faults or other priority actions. In general, the zone call sequence is processed from upstream zones, with respect to the flow of articles, to downstream zones. Call structure 122 begins at function 601 by setting initial values, then passes to function 602 which processes component configuration parameters. Function 603 processes operation control signals provided by the source of power including a start/stop/reset operation. Also, these signals are passed through the adjacent connected component. Function 604 performs an auto-addressing of low level network 50 in the manner disclosed in commonly assigned U.S. Pat. No. 7,035,714, the disclosure of which is hereby incorporated herein by reference. Function 605 allows the writing of hardware parameters to powered roller controllers 46 during the initial startup of the control component. Function 606 is used to read parameters in powered roller controller 46.

Function 608 processes each conveyor zone. Each zone has its own data area. This function handles the management of these data areas, as well as the basic call sequence for processing each configured zone. Function 610 writes all internal various status information to low level network 50, including, by way of example, motor status, photo-eye status, running status, fault/warning status and availability. Function 611 writes/logs user-defined messages for system faults, zone specific faults, and the like. The user-defined messages can be checked on-line using engineering tool 58.

As previously set forth, article-conveying system 30 is capable of controlling zones 34 on a zone-by-zone basis with different zones set to different modes and the mode for each zone capable of changing over time. An example of a first mode (mode 0) is illustrated in FIG. 9. Mode 0 is a minimum pressure, such as a zero pressure, accumulation mode with singulating output. Zero pressure accumulation is a zone-based accumulation. When unit loads are accumulated, there exists a one-zone distance between the leading edge of the upstream zone to the leading edge of the downstream unit loads. If articles are longer than one zone, additional zones will be utilized to accumulate the unit load. FIG. 9 illustrates the sequence of articles being fed from left to right and being accumulated in individual zones followed by discharge of articles from the zones. FIG. 10 shows the articles accumulated in a zero pressure accumulation mode. In FIG. 11, the articles are discharged utilizing singulation discharge. In singulation discharge, a unit load is released when the downstream unit load's trailing edge has passed through the corresponding article sensor 36. The zones, therefore, will start one-by-one from downstream to upstream resulting in approximately one-zone distance between unit loads.

A flowchart of a control function 124 for zero pressure accumulation with singulation discharge is illustrated in FIGS. 3a and 3b. Function 124 begins at 126 when a parcel enters a zero pressure accumulation component and a determination is made at 126 whether the zone is running. It is then determined at 128 whether the zone is in an energy management mode. Energy management is a way to reduce the amount of energy consumed by conveyor components if throughput is minimal. Energy management works by using a set amount of time to detect if articles are running on the conveyors. If no articles are detected within a set time, the component will go into energy management mode. In this mode, all zones within a component are powered off until a package is introduced to the conveyor or taken away from the conveyor. If the state of all photo-eyes, the RTS signal 54 and the RTR signal 56 remain unchanged for the duration of the timer, the zone will go into the powered off stage of energy management mode. The component will be powered back up upon a state change of the photo-eye, the RTS signal or the RTR signal.

It is then determined at 130 if all zones are clear of faults and at 132 whether the current zone is a slave zone. If it is a slave zone, it is determined at 134 whether the adjacent downstream zone is running. If not, the current zone stops at 136. If the downstream zone is running, the current zone runs at the downstream zone speed at 138. Once the article leaves the zone (140), the slave zone designation is reset at 142.

If it is determined at 132 that the present zone is not designated a slave zone, it is determined at 144 whether one zone gap length exists from leading edge to leading edge of articles. It is then determined at 146 whether additional gapping is required and, if so, extra gap is effected at 148. It is then determined at 150 whether the downstream RTR signal is present. If not, the upstream zone is stopped at 152 and the article stops at the upstream zone photo-eye 154. The article accumulates at 156 until the RTR signal is deactivated. If it is determined at 150 that the RTR signal is not present, the RTR delay time expires at 158 and it is determined at 160 whether the parcel is greater than a particular length. If so, a slave zone is assigned at 162 and the upstream zone is utilized at 164 to accumulate the article. It is then determined at 166 whether a parcel is accumulated on the current zone. If so, a determination is made at 168 whether a slave zone is available downstream. If so, the upstream zone runs at 170 causing the article to clear the current zone article sensor 172 and the current zone RTR signal to be activated at 174.

Thus, it is seen, at mode 0, when a component has more than one zone accumulated and the furthest downstream zone has begun to transfer, the next upstream zone will begin to run once the article's trailing edge has passed through the article detector. This effect is cascaded from downstream to upstream within the system. Therefore, unit loads will transfer within the correspondence of one zone distance between trailing edge to leading edge of the upstream unit load. During accumulation, zone conveyors will continuously run unless the zone has accumulated and is not in energy management. The unit load will transfer until the accumulating zone is reached. An accumulating zone is a zone in which the downstream zone is at rest with a package at the article sensor. The accumulating zone will begin the stopping routine when the article sensor is blocked. Unit loads will accumulate zone-by-zone from the furthest downstream to the furthest upstream zone. If a package is removed from the middle of the component with the parcels accumulated upstream and downstream of it, the zone will not begin to run.

Mode 1 is similar to mode 0, except that articles that are accumulated under zero pressure accumulation are discharged using train discharge. In particular, unit loads are released when the downstream motor runs which results in a train of unit loads without additional gaps being introduced, as illustrated in FIG. 12. A flowchart for the function of mode 1 is illustrated in FIGS. 14a and 14b. Because of the similarity to mode 0, many of the program steps are the same between modes 0 and 1. For function 180, when it is determined at 132 that the current zone is not a slave zone, it is determined at 182 whether the last zone RTR signal is present at 182. If it is, it is determined at 184 whether extra gapping is required. If not, the RTR delay time expires at 188 and the current zone runs at 190, thus releasing the parcel. The train RTR signal is then activated at 191.

If is determined at 182 that the last zone RTR signal is not present, it is determined at 192 whether extra gapping is required. If not, control passes to 150 where it is determined whether the downstream zone RTR signal is present. If not, the current zone is stopped at 196 and the upstream zone is halted at 154 when the article passes the article sensor. In this manner, the article is accumulated on that zone and any slave zone(s) at 156.

During mode 1, with the articles accumulated in the zones, when the furthest downstream zone receives an RTR signal and begins to transfer, all component zones will begin to run after a set delay. When the last zone in the component receives an RTR signal, the zone begins to run simultaneously relaying the RTR signal to the upstream zone. After receipt of the RTR signal, the upstream signal will delay starting the zone a set time. After this short delay, the zone will begin to run and the RTR signal will be exchanged to the next upstream zone. This effect is cascaded through the component to the upstream zone creating a train effect upon releasing.

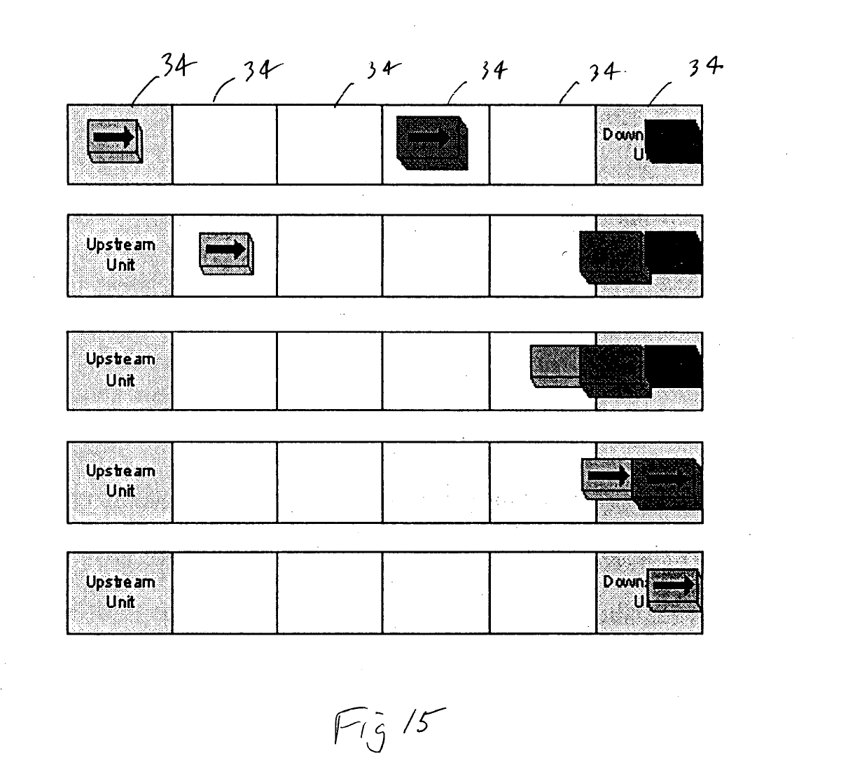

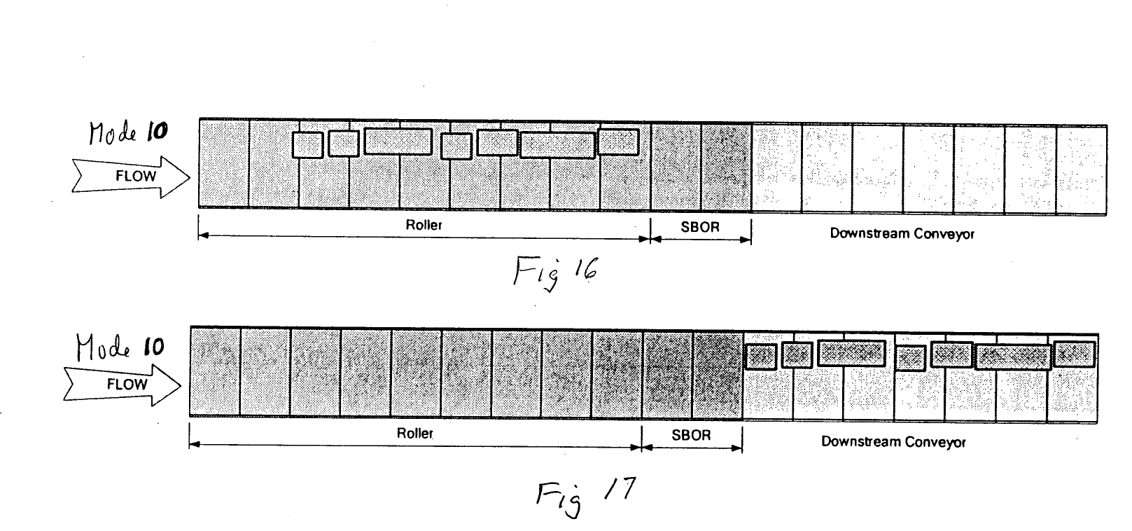

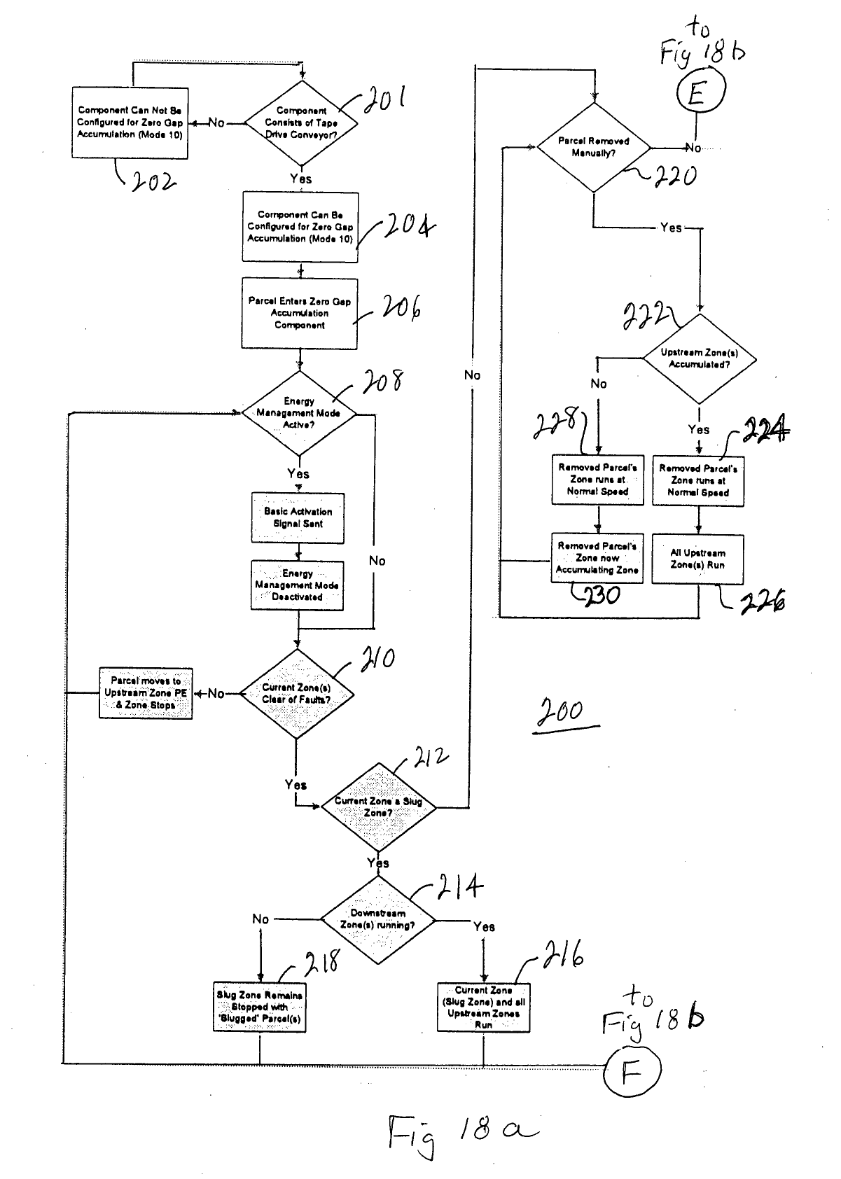

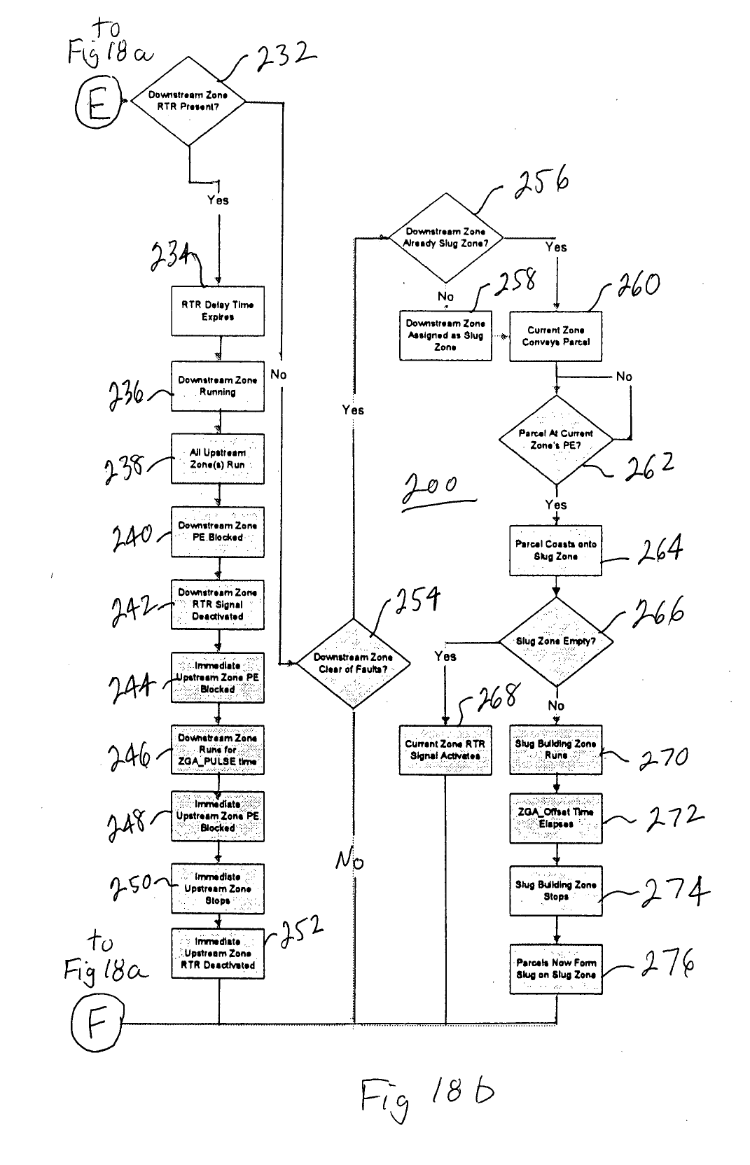

Another mode that can be selected by control 42 on a zone-by-zone basis for article-conveying system 30 is a minimum gap, such as a zero gap, accumulation mode (mode 10). The operation of mode 10 is illustrated in FIG. 15. Zero gap accumulation may be carried out with an article-conveying system that allows articles to drift, or coast, into stop zones. Examples of such system include the Model 1265 accumulator commercially marketed by Dematic Corp., Grand Rapids, Mich. and the conveyor disclosed in commonly assigned U.S. Pat. No. 6,899,219 for a TAPE DRIVE CONVEYOR, the disclosures of which are hereby incorporated herein by reference. In mode 10, a zone runs whenever its downstream zone is available. If the downstream zone is not available, the zone will accumulate unit loads to form a slug. During slug accumulation, the mode in the downstream zone is off. Unit loads enter the undriven zone and coast either to a gentle stop or into another unit load already on the zone. The unit loads will continue to form a slug until the downstream zone becomes available. Operation of mode 10 is illustrated in FIG. 15 in which articles are shown accumulating into a slug and then discharging. FIG. 16 illustrates a slug of accumulated articles accumulated in mode 10. FIG. 17 illustrates the discharge of articles in mode 10. Discharge of the unit loads depends on the downstream availability. When the downstream zone is available, the zone will release its unit loads whether these have formed a slug or not. A flowchart illustrating the mode 10 function 200 begins at 201 by determination of whether the article-conveying system consists of the type of conveyor that allows articles to coast into undriven zones (FIGS. 18a and 18b). If not, the zero gap accumulation mode cannot be entered (202). If so, the system enters the mode 10 at 204, 206 and a determination is made at 208 whether the energy management mode is active. If no faults are present (210), a determination is made at 212 whether the current zone is a slug zone. If so, a determination is made at 214 whether the downstream is running. If it is, the current zone and all upstream zones run at 216. If not, the present zone remains stopped with accumulated articles at 218.

If it is determined at 212 that the current zone is not a slug zone, a determination is made at 220 whether a parcel has been manually removed. If so, a determination is made whether the upstream zone from the removed parcel has accumulated at 222. If so, the removed parcel runs at its normal speed at 224 and all upstream zones are run at 226. If the upstream zone is not accumulated, the removed parcel zone runs at normal speed at 228 and the removed parcel zone is now accumulating at 230.

If it is determined at 212 that the current zone is not a slug zone and at 220 that a parcel has not been manually removed, a determination is made at 232 whether the downstream zone RTR signal is present. If it is, the RTR signal delay time expires at 234, the downstream zone is made to run at 236, and all upstream zones run at 238. Once the downstream zone senses an article at 240, the downstream zone RTR signal is deactivated at 242. Once the immediate upstream zone article sensor senses an article at 234, the downstream zones run for a particular time at 246 until the immediate upstream zone article sensor once again senses an article at 248, at which time the upstream zone is stopped at 250 and the RTR signal is deactivated for the upstream zone at 252.

If the downstream zone RTR signal is not present at 232 and there are no faults at the downstream zone (254), it is determined whether the downstream zone is already a slug zone at 256. If not, the downstream zone is defined as a slug zone at 258 and the current zone conveys articles at 260. When the article sensor of the current zone detects an article at 262, the article coasts onto the slug zone at 264. If it is determined at 266 that the slug zone is empty, the current zone RTR signal is activated at 268. If not, the slug-building zone runs at 270 until an offset timer elapses at 272, at which time the slug-building zone stops at 274 and the article now forms a slug at the slug zone 276.

In mode 10, the zones can be configured to run by default or be in an energy management mode. If configured to run by default, all zone conveyors will continue to run unless the zone is an accumulated zone. The mode 10 uses the slug zone to form slugs. If a slug zone is empty, an incoming article will travel to the upstream zones' article sensor and coast to a stop. When a zone comes to a stop, the article should be residing in the slug zone somewhere upstream of the article sensor. The next incoming article when passing the upstream zones' article sensor with respect to the slug zone will force the slug-building zone to run for a set amount of time, which time is changeable. A greater value in time will pack this slug more by running the article-conveying system longer. This will push the second package into the first package.

If an article is manually removed from a zone with no articles accumulated upstream of it, the removed article zone should begin to run at normal speed. This is now the zone where an incoming article would accumulate. If a package is manually removed with upstream zones accumulated, the removed article zone should begin to run at normal and the neighboring upstream zones should begin to transfer its articles. The articles will accumulate in what is now the furthest available downstream zone. This will create the same cascading effect in all of the upstream components that have previously accumulated.

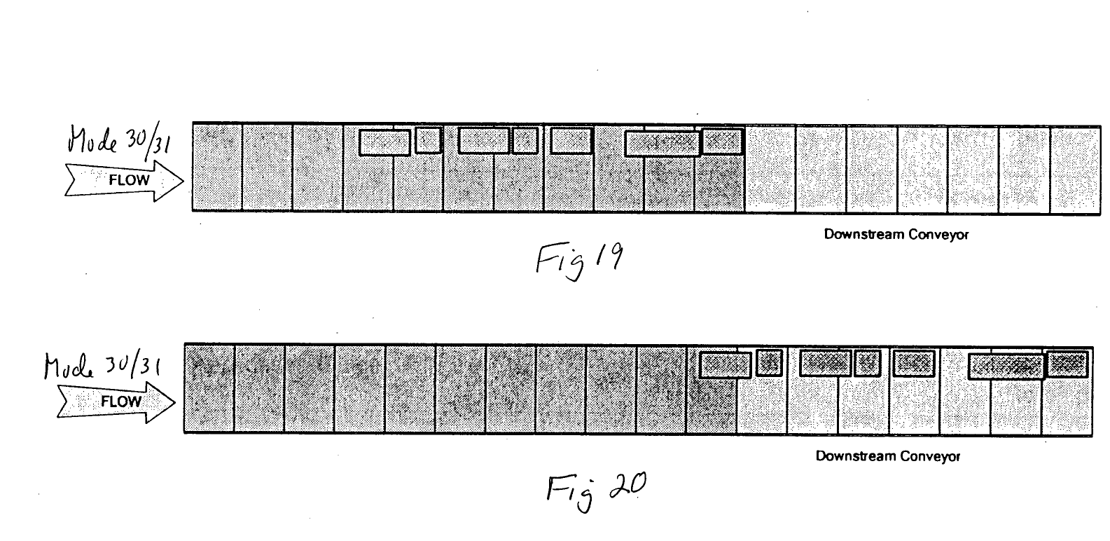

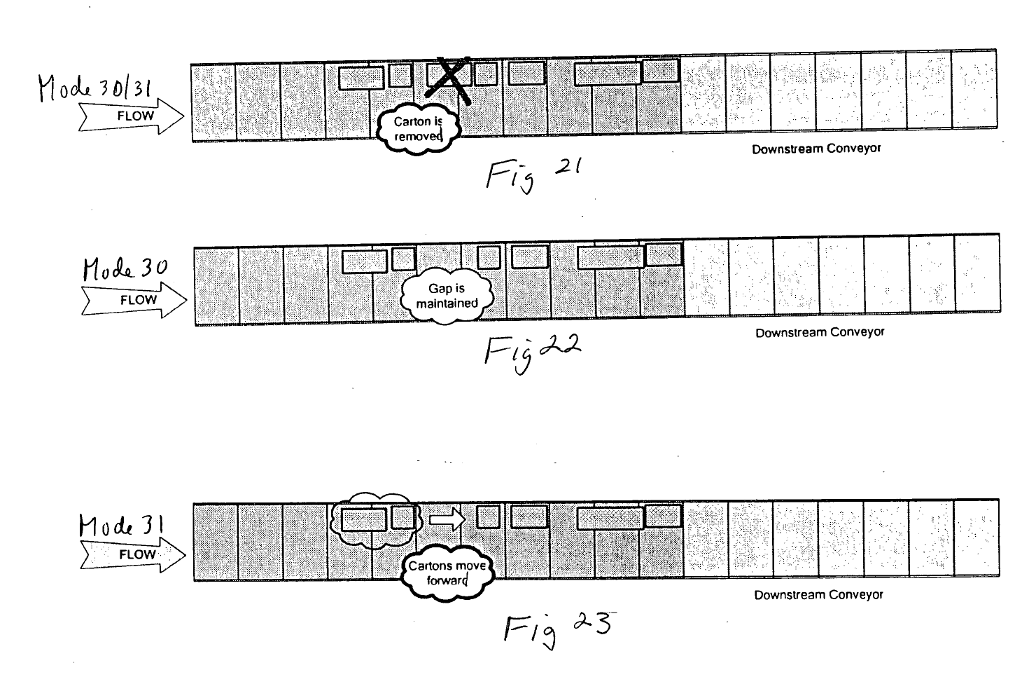

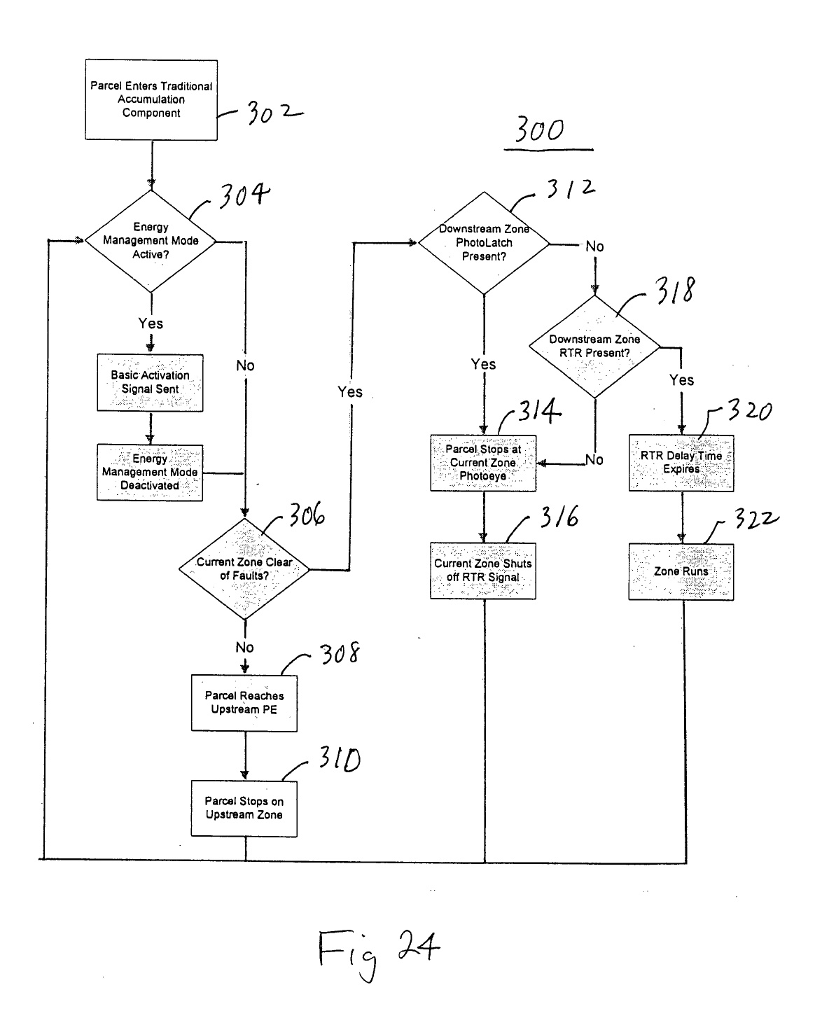

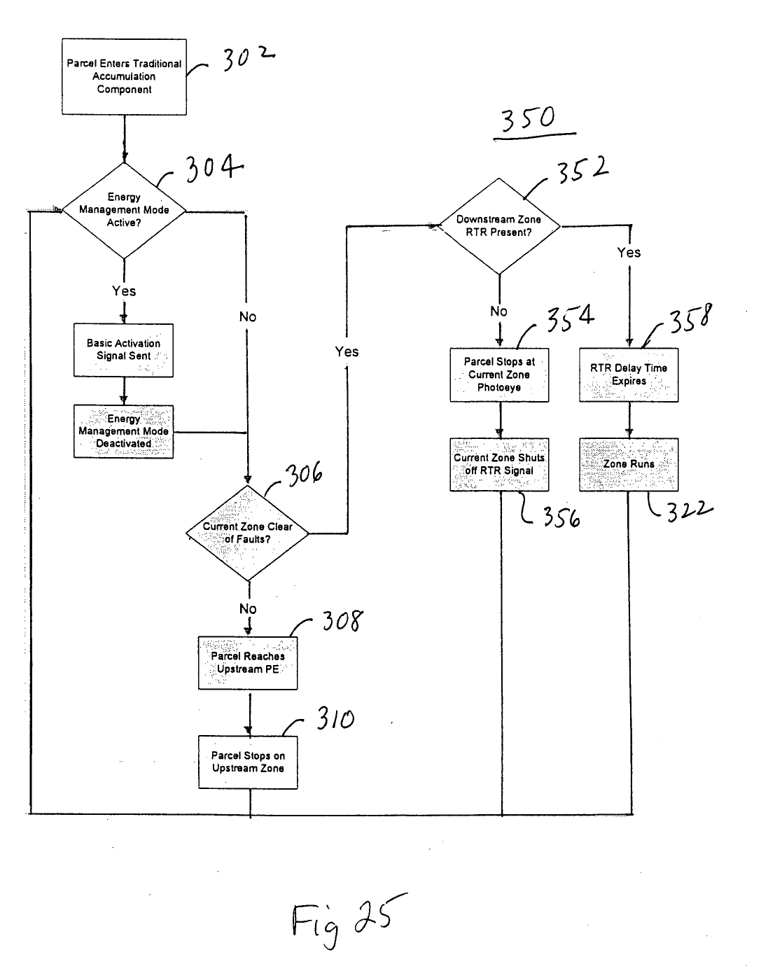

In a traditional accumulation mode (mode 30/31), multiple articles, or unit loads, may be accumulated per zone but not necessarily with zero gap between the articles. When the downstream conveyor is not available, the articles will advance to the article sensor and stop until the downstream zone becomes available again. Articles are accumulated from the furthest downstream zone to the furthest upstream zone. Upstream zones will only be able to stop once the downstream zone has accumulated. This means that once the accumulated zones' article sensor senses an article, the conveyor will stop. Operation of modes 30/31 is illustrated in FIGS. 19 and 20. FIG. 19 illustrates the accumulation of articles. FIG. 20 illustrates the discharge of accumulated articles. The difference between modes 30 and 31 can be illustrated with respect to FIGS. 21-23. Mode 30 incorporates an article sensor latch. As illustrated by comparing FIGS. 21 and 22 in mode 30, when the downstream conveyor is not available and the unit load has advanced to the article sensor, the zone will not return to run unless the downstream conveyor is available. Therefore, in this mode, if an article is removed manually, the zone will remain empty until the downstream conveyor is again available. Alternatively, the article sensor latch may be accompanied by a function for reducing the speed of the conveyor zone when an article enters that zone. This further ensures that an article will not overrun the article sensor at the end of that zone. Mode 31 does not incorporate an article sensor latch. Therefore, the conveyor zone will begin running again when its article sensor is clear. Therefore, in this mode, if an article is removed manually, the next article will automatically advance to the article sensor as illustrated by comparing FIGS. 21 and 23.

A flowchart illustrating a mode 30 function 300 begins at 302 by an article entering a zone 34. It is then determined at 304 whether the energy management mode is active and at 306 whether the zone is free of faults. If any faults are detected at 306, the article reaches the article sensor at the upstream zone at 308 and stops on the upstream zone at 310. If there are no faults, it is determined at 312 whether the downstream zone article sensor senses an article. If so, the article stops at the article sensor of the current zone at 314 and the current zone shuts off the RTR signal at 316. If it is determined at 312 that the downstream article sensor does not sense an article, it is determined at 318 whether the downstream zone RTR signal is present. If so, upon expiration of the RTR delay time at 320, the zone runs at 322.

A flowchart for a mode 31 function 350 is similar to operation of the mode 30 function. However, after it is determined at 306 that there are no current faults, function 350 determines at 352 whether the RTR signal is present at the downstream zone. If not, the article stops at the article sensor for the current zone at 354 and the current zone shuts off the RTR signal at 356. If it is determined at 352 that the RTR signal is present at the downstream zone, upon expiration of the RTR delay time at 358, the zone runs at 322. Thus, it can be seen that mode 351 does not incorporate an article sensor latch.

In modes 30 and 31, with energy management turned off, the zones will continuously run until they have been accumulated. In the illustrative embodiment, the accumulating zone does not slow down while transferring from the upstream zone. This provides more throughput than zero pressure accumulation modes 0 and 1.

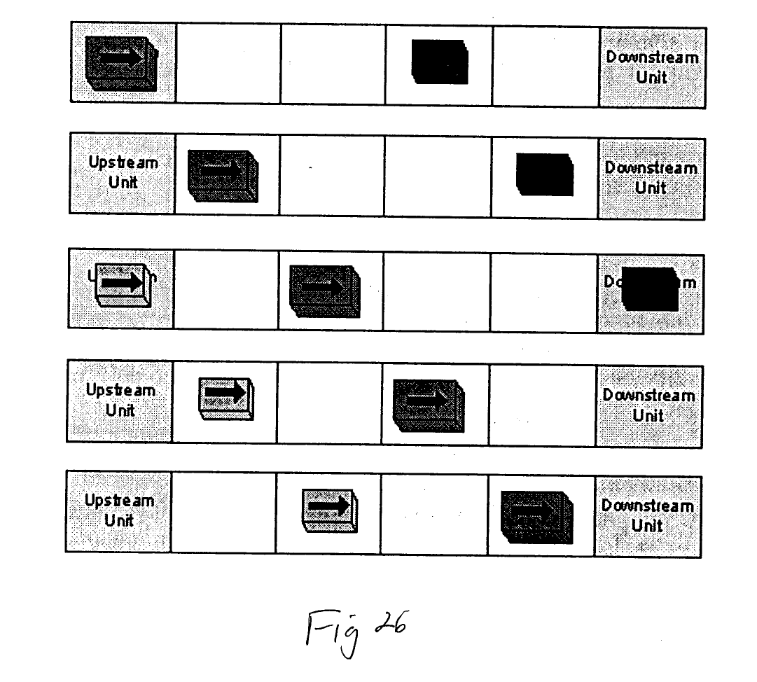

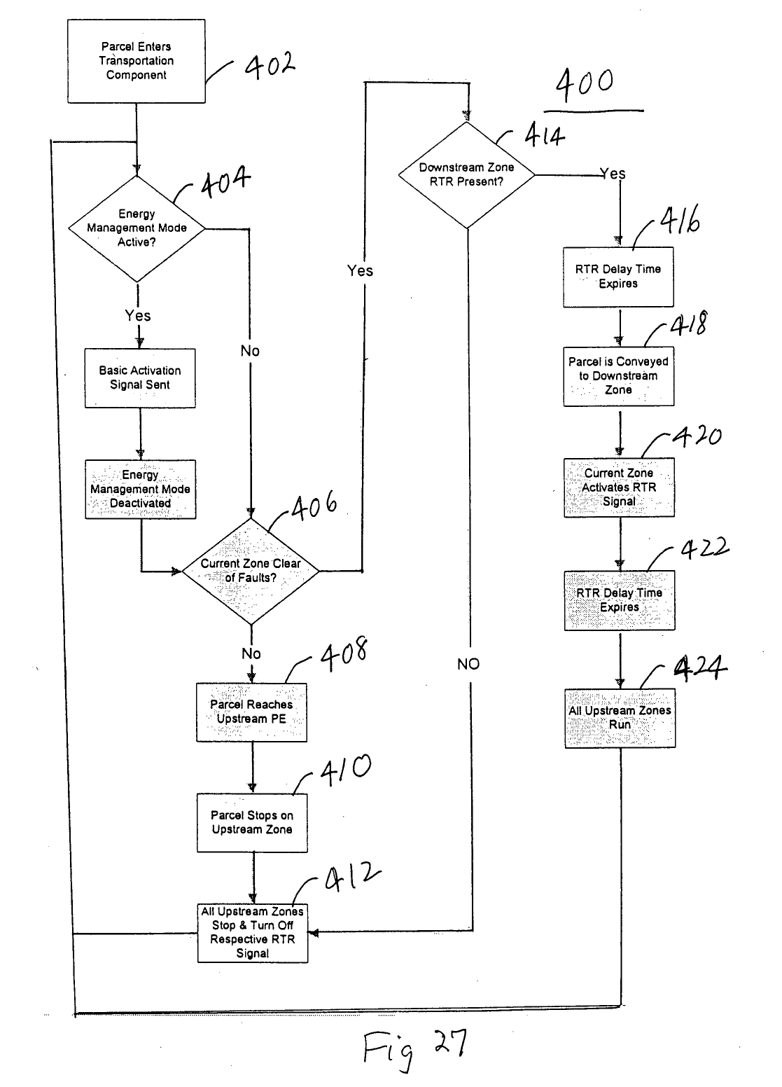

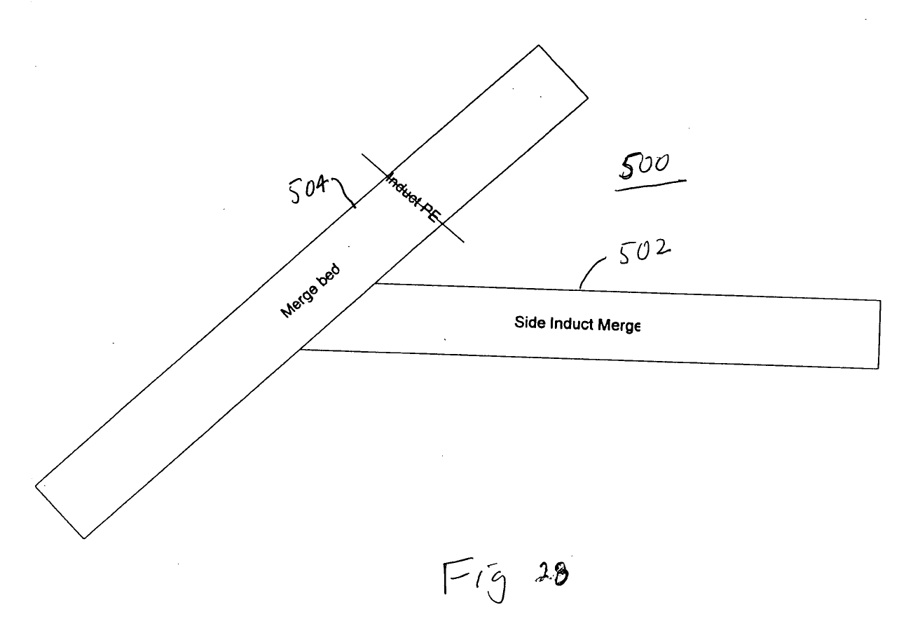

Article-conveying system 30 is additionally able to select among non-accumulation modes for each zone 34. An example of a non-accumulation mode is a transportation mode 50. Operation of transportation mode 50 is illustrated in FIG. 26. In transportation mode 50, the conveyors will continuously run unless there is no RTR signal. A zone will run continuously when the zone is enabled, there are no faults or jams detected in the zone, and the downstream zone is available to accept the load. A flowchart of a transportation mode function 400 is illustrated in FIG. 27. In function 50, the parcel enters the zone at 402 and a determination is made at 404 whether the zone is in an active energy management mode. A determination is then made at 406 whether there are any current faults with that zone. If there are any current faults, when the article reaches the upstream article sensor at 408, the article stops on the upstream zone at 410 and all upstream zones are stopped and turn off their respective RTR signals at 412.

If it is determined at 406 that there are no present faults, it is determined at 414 whether the RTR signal is present in the downstream zone. If so, then, upon expiration of the RTR delay time at 416, the article is conveyed to the downstream zone at 418 and the current zone activates its RTR signal at 420. Upon expiration of the RTR delay time at 422, all upstream zones run at 424. If it is determined at 414 that the RTR signal is not present from the downstream zone, all upstream zones stop and turn off their RTR signals at 412. Thus, it is seen in the transportation mode 50, a zone will run when its RTR signal of the downstream zone is on. The zone will stop once the RTR signal is turned off by the downstream zone. Due to the fact that a zone in mode 50 runs only when the RTR signal from the downstream zone is present, removing a parcel from within the zone will not necessarily cause the zone to run. The zone will remain stopped until the RTR signal is received from the downstream zone. The most downstream zone will get its RTR signal from system controller 44 or through a discrete input signal that will denote that the downstream system is ready to receive.

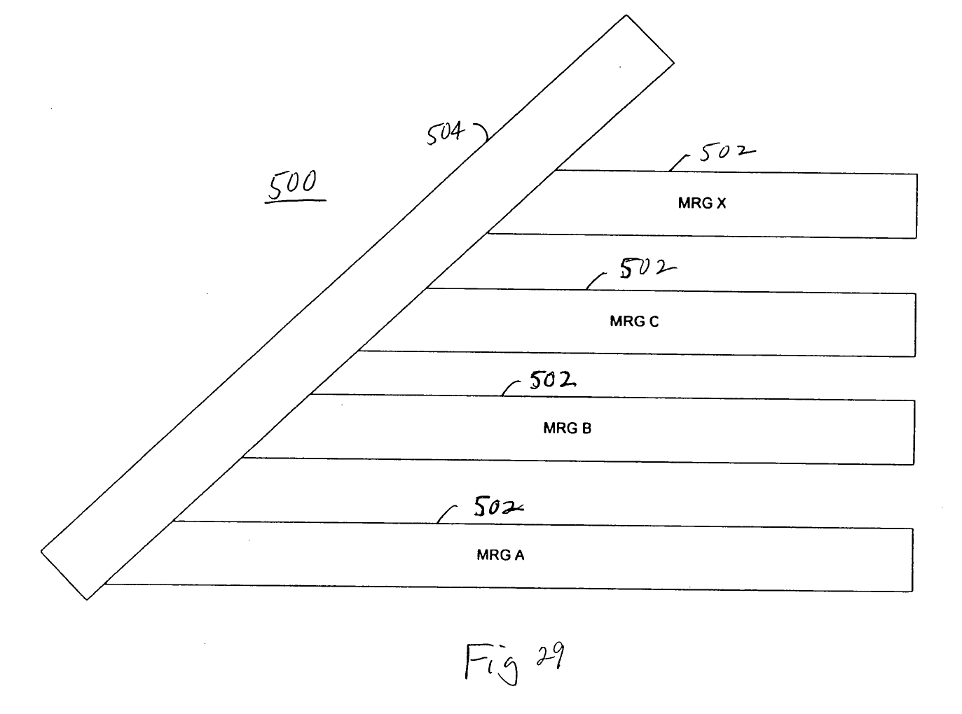

Other non-accumulation modes are possible with article-conveying system 30. One example is a time-release merge (mode 2). Mode 2 is illustrated with respect to FIGS. 28 and 29. In mode 2, one or more merge components 502 must merge its product with other components and this must be done in an organized fashion to avoid collisions. To this end, each merge component 502 coordinates its activities with the others in a merge subsystem 500. This may be accomplished by passing a “token” among the components. This so-called token is a collection of data that is interpreted by each component and changed under a set of rules by each component in merge system 500. In this mode, each line 502 releases product onto a merge common bed 504 for a predetermined period of time. This time may be set, for example, from approximately 8 to approximately 5 seconds. After the time has expired, the next line in the sequence will release. A sequencing section deals with a determination of which line is next to release. At every scan of every component of the merge subsystem, several factors are considered to determine which of the lines will next release. These factors will include whether the line is enabled to release, whether the line's priority is equal to or higher than that of the other lines, and whether there is product that is ready to be released that is not already being released. Of course, other merge functions may be utilized with system 30, such as disclosed in commonly assigned U.S. Pat. No. 6,918,484 and pending application Ser. No. 60/597,178 filed Nov. 15, 2005, by Lupton for an ARTICLE ACCUMULATION METHOD AND APPARATUS, the disclosures of which are hereby incorporated herein by reference.

The invention is not intended to be limited to any particular hardware configuration. By hardware configuration, it is meant mechanical hardware as well as electrical/electronic hardware. For example, the invention may be utilized with straight bed sections, incline sections, extendable conveyors, lift gates, curved conveyors, and the like. Also, the invention may be utilized with various forms of electronic controls incorporating various architectures and topologies.

The disclosed embodiments provide enormous design flexibility. For example, in the case of a sortation system, the conveyors feeding articles to the sorter may be run in a zero pressure accumulation mode if the sorter is being run at a slow speed or may be operated at a zero gap mode if the sorter is run at a higher speed. As another example, a trailer loader may be operated in a zero pressure accumulation mode when the loader is at least partially retracted so that the operator can remove a package without other articles engaging the operator's hands. However, when the trailer loader is fully extended, the operator may wish to place it in a transportation mode to have a constant feed of articles. As another example, although the invention may be utilized in combination with conveyor systems in which accumulation is possible on curved sections, for example, as disclosed in commonly assigned U.S. Pat. No. 6,971,510, the disclosure of which is hereby incorporated herein by reference, the zones in the curved portions may be set to a transport mode even though they have accumulation capability. These curved zones could also be placed in an accumulation mode at another time, if desired, for additional accumulations.

Other flexibilities are provided by the disclosed embodiments. For example, the use of an article sensor latch allows the avoidance of articles overshooting an article sensor. This can be combined with control of a downstream zone from the article sensor to allow it to be more controllable. This may be used, for example, at the end of a train discharge where it is desired to stop a zone when the last carton is in that zone's article sensor. Otherwise, the zones will continue to run. This function will be lost if the remaining article and the slug drifts through the article sensor. The use of an article sensor latch in combination with a controlled speed downstream zone reduces the likelihood of that occurrence. The reduction in speed can be adjustable.

It is also seen that, in certain modes, articles longer than a single zone length can be handled. Thus, multiple zones can be controlled together as one according to article length.

The ability to set the mode for each zone independently of the other zones and to communicate between adjacent zones by virtual signals allows the hardware structure of the electronic system to be more cost effective. For example, one system controller or bed level controller may be utilized to control a large number of zones, such as 30 zones or greater. Also, the speed of each zone may be varied independently of other zones. Because each zone is its own entity, articles can be tracked through each zone, such as by the position of its leading edge, trailing edge, as well as other data, such as weight, and the like. This is facilitated by the ability to control a package based upon its position rather than timers. For example, when an article enters a zone, as defined by its trailing edge, that zone may look toward an upstream gap utilizing ticks. The speed of the upstream zone may be controlled to adjust the gap. For example, the goal may be for zero gap or some other gap.

At frequent intervals, such as at millisecond intervals, the control may scan all of the zones to obtain positions of articles. The control can then adjust the positioning of articles based upon upstream locations where articles enter the system. Also, articles can be accurately positioned when used with a right-angle transfer to match the position of the right-angle transfer with correct gaps between articles. This reduces the gaps between articles thereby increasing throughput of the system.

The use of object-oriented programming by way of engineering tool 58 allows detailed parameters of the zone operation to be controlled at a higher level.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. An article-conveying system, comprising:
a conveying surface for conveying articles, said conveying surface defining a series of tandem zones, each of said zones including an article sensor and an actuator, said article sensor sensing the presence of an article in the respective zone, said actuator causing the portion of said conveying surface at that zone to be driven when said actuator is operated; and
a control, said control receiving inputs from said article sensors at said zones, said control controlling said actuators for said zones, said control including software, said software defining objects, each of said objects corresponding to one of said zones, said software enabling virtual signals between said objects, said virtual signals related to movement of articles along said conveying surface, each of said objects adapted to receive a mode input, wherein each of said objects processes said virtual signals as a function of the mode of that object.

2. The system as claimed in claim 1 wherein said control is adapted to setting the mode individually for each of said objects.

3. The system as claimed in claim 1 wherein said signals comprise communications between objects associated with adjacent ones of said zones.

4. The system as claimed in claim 3 wherein said signals identify at least one chosen from (i) a zone having an article ready to be transferred to an adjacent downstream zone; and (ii) a zone ready to receive an article from an adjacent upstream zone.

5. The system as claimed in claim 4 wherein said modes are selected from at least one non-accumulation mode and at least one accumulation mode.

6. The system as claimed in claim 5 wherein said at least one accumulation mode is chosen from (i) minimum gap accumulation; (ii) minimum pressure accumulation; and (iii) traditional accumulation.

7. The system as claimed in claim 5 wherein said accumulation mode includes a discharge mode, said discharge mode comprising train discharge or singulation discharge.

8. The system as claimed in claim 5 wherein said at least one non-accumulation mode comprises at least one chosen from a transportation mode, a merge mode and an induct mode.

9. The system as claimed in claim 1 wherein said software includes a call structure, said call structure calling said objects in a particular call sequence.

10. The system as claimed in claim 9 wherein said call sequence is from downstream zones to upstream zones in the direction of article flow.

11. The system as claimed in claim 1 wherein said actuator comprises a motorized roller, said motorized roller having a tubular shell and an electrical motor inside said shell for rotating said shell.

12. The system as claimed in claim 11 wherein said control monitors rotation of said motorized rollers and develops a position parameter for said portions of said conveying surface as a function of said rotation of said motorized rollers.

13. The system as claimed in claim 12 wherein said control maintains said position parameter during periods of lost electrical energy.

14. The system as claimed in claim 1 including a plurality of said conveying surfaces and a plurality of said controls, each controlling one of said conveying surfaces, wherein said plurality of controls are interconnected.

15. The system as claimed in claim 1 wherein said article sensor comprises a photo sensor, wherein said control includes a photo sensor latch mode, when one of said zones is in said photo sensor latch mode the corresponding portion of said conveying surface will not transport articles unless the adjacent downstream zone is available for receiving an article.

16. The system as claimed in claim 15 wherein when one of said zones is in said photo sensor latch mode, the corresponding portion of said conveying surface operates at a reduced speed to ensure that an article stops at the corresponding photo sensor.

17. An article-conveying system, comprising:
a conveying surface for conveying articles, said conveying surface defining a series of tandem zones, each of said zones including an article sensor and an actuator, said article sensor sensing the presence of an article in the respective zone, said actuator causing the portion of said conveying surface at that zone to be driven when said actuator is operated; and
a control, said control receiving inputs from said article sensors at said zones, said control controlling said actuators for said zones, said control including software, said software defining objects, each of said objects corresponding to one of said zones, said software enabling virtual signals between said objects;
wherein said actuator comprises a motorized roller, said motorized roller having a tubular shell and an electrical motor inside said shell for rotating said shell;
wherein said control monitors rotation of said motorized rollers and develops a position parameter for said portions of said conveying surface as a function of said rotation of said motorized rollers;
wherein said control generates said virtual signals at least partially as a function of the position parameter.

18. The system as claimed in claim 17 wherein each of said objects processes said virtual signals as a function of the mode of that object and wherein said control is adapted to setting the mode individually for each of said objects.

19. The system as claimed in claim 17 wherein said signals comprise communications between virtual objects associated with adjacent ones of said zones.

20. A method of conveying articles, said method comprising:
providing a conveying surface and conveying articles with said conveying surface, said conveying surface defining a series of tandem zones, each of said zones including an article sensor and an actuator;
sensing with said article sensor the presence of an article in the respective zone, driving the portion of said conveying surface at that zone when said actuator is operated; and
receiving inputs from said article sensors at said zones and controlling said actuators for said zones as a function of said inputs including defining objects, each of said objects corresponding to one of said zones;
enabling virtual signals between said objects, said virtual signals related to movement of articles along said conveying surface each of said virtual objects adapted to receive a mode input, including processing said virtual signals as a function of the mode of that object.
